(19) United States
(12) Patent Application Publication
(10) Pub. No.: US 2015/0054757 A1
(43) Pub. Date: Feb. 26, 2015

(54) TOUCH SCREEN APPARATUS AND DISPLAY APPARATUS

(71) Applicant: SHARP KABUSHIKI KAISHA, Osaka (JP)

(72) Inventor: Tatsuro KURODA, Osaka-shi (JP)

(21) Appl. No.: 14/329,383

(22) Filed: Jul. 11, 2014

(30) Foreign Application Priority Data
Aug. 26, 2013 (JP) 2013-174739

(51) Int. Cl. G06F 3/0354; G06F 3/038

(52) U.S. Cl. CPC G06F 3/03545; G06F 3/0386
USPC 345/173; 345/179

(57) ABSTRACT

The touch screen apparatus includes a display screen; a calculation unit configured to calculate an angle between a direction in which a direction of the pen tip is projected on the display screen when the pen tip of the touch pen is touched to the display screen and a reference direction on the display screen; and a determination unit configured to determine a direction of the image of the writing brush shape which is drawn depending on the angle calculated by the calculation unit, and is configured to detect the position when the pen. tip of the touch pen is touched to the display screen and draw the image of the writing brush shape on the detected position.

### CROSS-REFERENCE TO RELATED APPLICATIONS

This Nonprovisional application claims priority under 35 U.S.C.§119(a) on Patent Application No.2013-174739 filed in Japan on Aug. 26, 2013, the entire contents of which are hereby incorporated by reference.

### BACKGROUND

The present invention relates to a touch screen apparatus capable of drawing an image on a display screen by a touch pen and a display apparatus including the touch screen apparatus.

### DESCRIPTION OF THE RELATED ART

There is a touch panel (touch screen) apparatus which includes a display unit formed of a touch panel and may draw brush characters by writing characters on the display unit by using a touch pen. For example, there is a touch panel apparatus configured to draw brush characters using only a change in a moving speed of the touch pen; select one of a plurality of shapes of writing, such as flick, blur, bleed, and stop of the writing brush which is previously prepared within the apparatus, depending on the moving speed of the touch pen; control a point image without blur and a point image with blur to overlap each other; and sequentially draw the overlapped point images on the touch panel (see Japanese Patent Application Laid open No. 2008-140352).

### SUMMARY

However, the touch panel apparatus disclosed in Japanese Patent Application Laid-open No. 2008-140352 may draw the shapes of writing such as flick, blur, bleed, and stop of the writing brush but considers only the change in the moving speed of the touch pen. Therefore, for example, it is not possible to differentiate a writing-out portion of the writing brush, in more detail, the direction in which the writing brush is written-out. For this reason, when a user writes characters with the touch pen, even though a user starts to write the characters with the touch pen in any direction, the image of the writing brush to be drawn becomes an image having exactly the same shape, and thus the writing-out portion of the writing brush may not be drawn as intended by a user.

In consideration of the above-described circumstances, it is an object of the present invention to provide a touch panel apparatus capable of drawing a writing-out portion of a writing brush as intended by a user and a display apparatus including the touch panel apparatus.

According to an embodiment of the present invention, there is provided a touch panel apparatus which includes a display screen, and is configured to detect a position when a pen tip of a touch pen is touched to the display screen, and draw an image of a writing brush shape at the detected position, the touch panel apparatus including: a calculation unit configured to calculate an angle between a direction in which a direction of the pen tip is projected on the display screen when the pen tip of the touch pen is touched to the display screen and a reference direction on the display screen; and a determination unit configured to determine a direction of the image of the writing brush shape which is drawn depending on the angle calculated by the calculation unit.

In the touch panel apparatus according to the present invention, the touch pen may include a pen body part having an attaching part to which the pen tip is attached, wherein the pen tip is capable of three dimensionally displaced around the attaching part, and the pen body part may include: a reference sensor configured to detect a reference direction on the display screen; and a displacement sensor configured to detect a three-dimensional displacement of the pen tip, wherein the calculation unit may be configured to calculate the angle based on the reference direction detected by the reference sensor and the displacement detected by the displacement sensor.

In the touch panel apparatus according to the present invention, the reference direction may be a gravity direction.

In the touch panel apparatus according to the present invention, the reference direction may be a geomagnetic direction.

According to another embodiment of the present invention, there is provided a display apparatus, including: the touch panel apparatus according to any one of the above-described inventions; and a drawing unit configured to draw an image of a writing brush shape which is formed in a wide width toward the direction determined by the determination unit on the display screen.

According to the present invention, it is possible to draw the writing-out portion of the writing brush as intended by a user.

The above and further objects and features will more fully be apparent from the following detailed description with accompanying drawings.

### BRIEF DESCRIPTION OF THE DRAWINGS

FIG. 1 is a schematic diagram illustrating an example of a configuration of a display apparatus according to an embodiment of the present invention.

FIG. 2 is a block diagram illustrating an example of a configuration of a touch panel apparatus according to the embodiment of the present invention.

FIG. 3 is a schematic diagram illustrating an example of a configuration of a light emitting unit and a light receiving unit of the touch panel apparatus according to the embodiment of the present invention.

FIG. 4 is a schematic diagram illustrating an example of an appearance of hovering by a touch pen according to the embodiment of the present invention.

FIG. 5 is a schematic diagram illustrating an example of a configuration of the touch pen according to the embodiment of the present invention.

FIG. 6 is a schematic diagram illustrating a first example of the touch pen according to the embodiment of the present invention.

FIG. 7 is a diagram describing an example of calculation of an angle by the touch pen of the first example.

FIG. 8 is a diagram describing an example of calculation of an angle by the touch pen of the first example when considering a reference direction.

FIG. 9 is a diagram describing an example of a drawing of an image of a writing brush shape by the touch pen of the first example based on a gravity direction.

FIG. 10 is a diagram describing another example of a drawing of an image of a writing brush shape by the touch pen of the first example based on the gravity direction.

FIG. 11 is a diagram describing another example of calculation of an angle by the touch pen of the first example when considering a reference direction.

FIG. 12 is a diagram describing an example of a drawing of the image of a writing brush shape by the touch pen of the first example based on a north direction.

FIG. 13 is a schematic diagram illustrating a second example of the touch pen according to the embodiment of the present invention.

FIG. 14 is a schematic diagram illustrating an example of a pressure sensor of the touch pen of the second example.

FIG. 15 is a diagram describing an example of calculation of an angle by the touch pen of the second example.

FIG. 16 is a schematic diagram illustrating a third example of the touch pen according to the embodiment of the present invention.

FIG. 17 is a schematic diagram illustrating a fourth example of the touch pen according to the embodiment of the present invention.

FIG. 18 is a diagram describing an example of calculation of an angle by the touch pen of the fourth example.

FIG. 19 is a schematic diagram illustrating a fifth example of the touch pen according to the embodiment of the present invention.

FIG. 20 is a schematic diagram illustrating a sixth example of the touch pen according to the embodiment of the present invention.

FIG. 21 is a diagram describing an example of calculation of an angle by the touch pen of the sixth example.

FIG. 22 is a diagram describing an example of a method of detecting a strain of a strain gauge of the sixth example.

FIG. 23 is a schematic diagram illustrating a seventh example of the touch pen according to the embodiment of the present invention.

FIG. 24 is a diagram describing an example of calculation of an angle by the touch pen of the seventh example.

### DETAILED DESCRIPTION

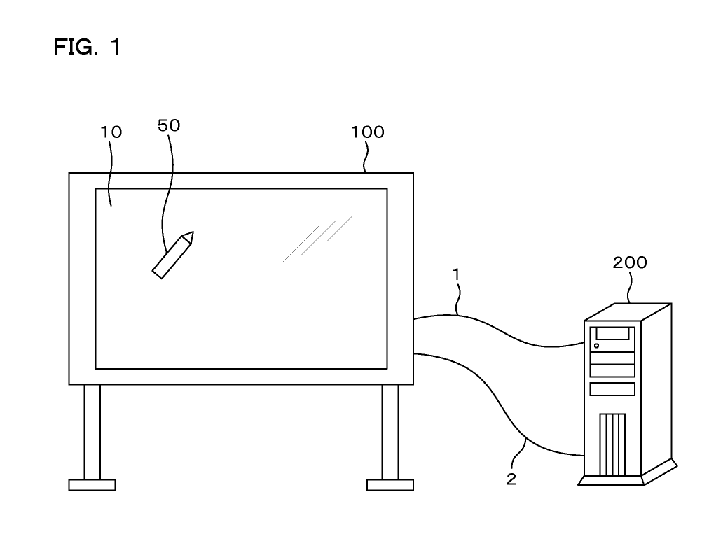

Hereinafter, embodiments of the present invention will be described with reference to the accompanying drawings. FIG. 1 is a schematic diagram illustrating an example of a configuration of a display apparatus according to an embodiment of the present invention. The display apparatus includes a touch panel (touch screen) apparatus 100, a personal computer (hereinafter, referred to as a “PC”) 200 and the like. The touch panel apparatus 100 and the PC 200 are connected with each other by communication lines 1 and 2.

The touch panel apparatus 100 includes a display screen 10. When a user touches (contacts) the display screen 10 with a touch pen 50, a finger or the like, the touch panel apparatus 100 transmits positional information on the touched display screen 10 to the PC 200 through the communication line 1 (for example, a USB cable or the like). The PC 200 has a function as a drawing unit and transmits an image signal to the touch panel apparatus 100 through the communication line 2 (for example, a high-definition multimedia interface (HDMI) cable) (HDMI is a registered trademark).

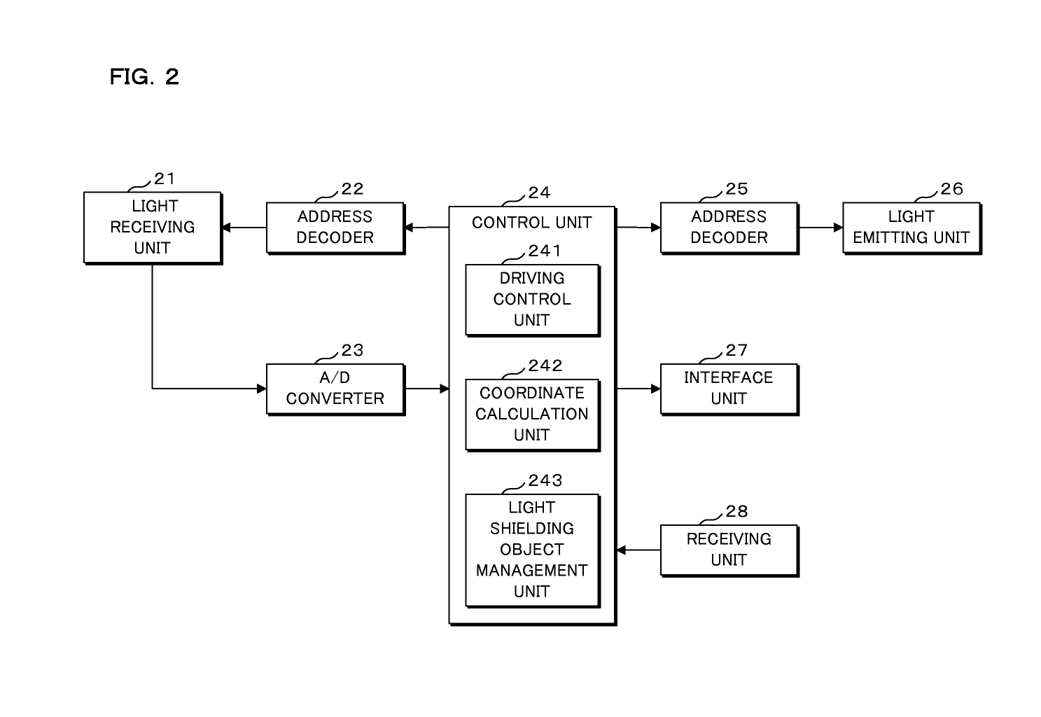

FIG. 2 is a block diagram illustrating an example of a configuration of the touch panel apparatus 100 according to the embodiment of the present invention. The touch panel apparatus 100 includes a light receiving unit 21, address decoders 22 and 25, an A/D converter 23, a control unit 24, a light emitting unit 26, an interface unit 27, a receiving unit 28 and the like. Further, the control unit 24 includes a driving control unit 241, a coordinate calculation unit 242, and a light shielding object management unit 243 and the like.

The light receiving unit 21 is a plurality of light receiving elements and has photo diodes to receive infrared light. Further, the light emitting unit 26 is a plurality of light emitting elements and has light emitting diodes to emit infrared light.

The address decoder 25 directs the light emitting diodes to sequentially emit light under a control of the control unit 24. Further, the address decoder 22 directs the photo diodes to sequentially receive light under the control of the control unit 24.

The A/D converter 23 converts an analog signal received by the light receiving unit into a digital signal and outputs the digital signal to the control unit 24.

The driving control unit 241 controls the address decoders 22 and 25 to control an order of the light emitting diodes which emit light and an order of the photo diodes which receive light.

The coordinate calculation unit 242 calculates the positional information (coordinates on the display screen) representing which portion of the display screen 10 the touch pen 50, the finger or the like are touched, based on the digital signal output from the A/D converter 23. The control unit 24 transmits the calculated positional information to the PC 200 through the interface unit 27.

The light shielding object management unit 243 manages a position of a light shielding object (the touch pen 50 or the like) when corresponding to a multipoint input.

The receiving unit 28 receives information (for example, a pen down signal representing that a pen tip is touched to the display screen 10, information of the pen tip in a drawing direction thereof or the like) transmitted by the touch pen 50.

Further, the control unit 24 may include a CPU, a memory and the like and may store a control program controlling an operation of the control unit 24 to determine the operation of the control unit 24.

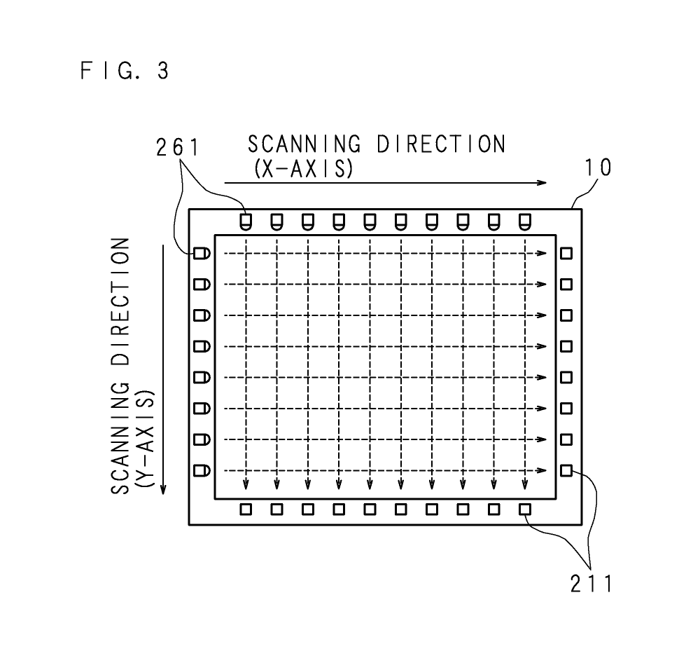

FIG. 3 is a schematic diagram illustrating an example of a configuration of the light emitting unit 26 and the light receiving unit 21 of the touch panel apparatus 100 according to the embodiment of the present invention. As illustrated in FIG. 3, a plurality of light emitting diodes 261 included in the light emitting unit 26 are disposed along an edge of one side in an X-axis direction of a rectangular display screen 10 and an edge of one side in a Y-axis direction thereof. Each light emitting diode 261 may emit infrared light. FIG. 3 illustrates the infrared light emitted by each light emitting diode 261 by dotted lines. Further, each light emitting diode 261 is disposed so that optical paths of the infrared light emitted therefrom are parallel with each other along the display screen. 10. The light emitting unit 26 has a multiplexer (not illustrated), and each light emitting diode 261 is connected to the multiplexer.

The plurality of photo diodes 211 included in the light receiving unit 21 are disposed at a side corresponding to one side of the display screen 10 at which each light emitting diode 261 is disposed. That is, each photo diode 211 is disposed to face the light emitting diode 261 along the edge of one side in the X-axis direction of the rectangular display screen 10 and the edge of one side in the Y-axis direction thereof. Any one of the light emitting diodes 261 corresponds to any one of the photo diodes 211. That is, the infrared light emitted by one light emitting diode 261 is received by one photo diode 211 which is disposed in association with the corresponding light emitting diode 261, and is not received by the other photo diodes 211. The light receiving unit 21 has a multiplexer (not illustrated) and each photo diode 211 is connected to the multiplexer.

The above-described driving control unit 241 outputs a signal for sequentially scanning the plurality of light emitting diodes 261 to the address decoder 25 and outputs a signal for sequentially scanning the plurality of photo diodes 211 to the address decoder 22.

The address decoder 25 outputs a signal selecting any one of the light emitting diodes 261 in the light emitting unit 26 to the light emitting unit 26, depending on the signal output by the driving control unit 241. The selected light emitting diode 261 emits the infrared light for a predetermined time.

The address decoder 22 outputs a signal selecting any one of the photo diodes 211 in the light receiving unit 21 to the light receiving unit 21, depending on the signal output by the driving control unit 241 The selected photo diode 211 receives the infrared light emitted by the light emitting diode 261 in association therewith for a predetermined time.

The selected photo diode 211 outputs a strength of the received infrared light, for example, a strength signal represented by a voltage value to the A/D converter 23.

The A/D converter 23 converts the acquired strength signal into, for example, a digital signal of 8 bits and outputs the converted strength signal to the control unit 24.

The control unit 24 acquires the strength signal from all the photo diodes 211 of the light receiving unit 21. For example, the control unit 24 controls the light emitting diodes 261 of the light emitting unit 26 to emit light from an end in the scanning directions of the X axis and the Y axis, and the photo diodes 211 to sequentially receive the light in association with the light emitting diodes 261, thereby acquiring the strength signal from all the photo diodes 211.

The control unit 24 calculates an amount of light received by each photo diode 211 based on the strength signal acquired from all the photo diodes 211. When the calculated amount of received light for the photo diode 211 is a predetermined threshold value or more, the control unit 24 determines that the optical path of the infrared light received by the corresponding photo diode 211 is not interrupted, that is, the infrared light, is not interrupted by the touch pen 50 or the like. Further, when the calculated amount of received light for the photo diode 211 is less than the predetermined threshold value, the control unit determines that the optical path of the infrared light received by the corresponding photo diode 211 is interrupted, that is, the infrared light is interrupted by the touch pen 50 or the like.

Therefore, the control unit 24 specifies the photo diode 211 in which the optical path of the received infrared light is interrupted. The coordinate calculation unit 242 calculates a position in which the light is shielded on the display screen 10, that is, the positional information (coordinates) touched by the touch pen 50 or the finger based on the position of the specified photo diode.

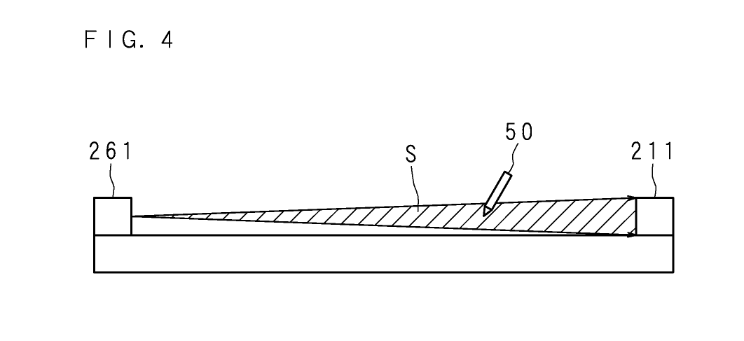

FIG. 4 is a schematic diagram illustrating an example of an appearance of hovering by the touch pen 50 according to the embodiment of the present invention. An example of FIG. 4 illustrates a hovering state before the touch pen 50 is touched to the display screen 10. The hovering means a state in which a pen tip of the touch pen 50 is slightly spaced apart from the display screen 10. As illustrated in FIG. 4, the infrared light emitted by the light emitting diode 261 is in a state in which the infrared light is diffused to a region S represented by a symbol S until it is received by the corresponding photo diode 211. In this state, when the pen tip of the touch pen 50 interrupts the region 5, it is wrongly determined that the touch pen is touching by shielding the infrared light even though the pen tip is not touched to the display screen 10. Therefore, by determining that the display screen did not touch until the pen down representing that the pen tip of the touch pen 50 touches the display screen 10 is detected, the pen down (touch) and the pen up (non-touch) of the touch pen 50 may be accurately determined.

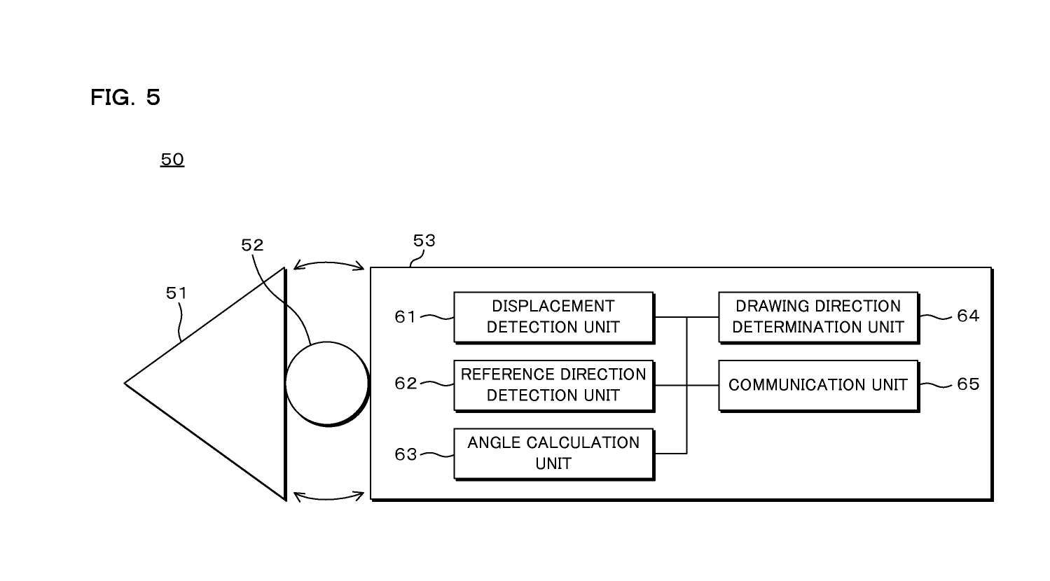

FIG. 5 is a schematic diagram illustrating an example of the configuration of the touch pen 50 according to the embodiment of the present invention. As illustrated in FIG. 5, the touch pen 50 includes a pen tip 51 of which a tip end portion is thin, a pen body part 53 which may be held by a user and is, for example, formed in a cylindrical shape, an attaching part 52 which attaches the pen tip 51 to the pen body part 53 and the like. Further, the pen body part 53 includes a displacement detection unit 61, a reference direction detection unit 62, an angle calculation unit 63, a drawing direction determination unit 64, a communication unit 65 and the like.

The attaching part 52 is, for example, a ball joint 52 formed in a spherical shape, and the pen tip 51 is capable of three-dimensionally displaced around the attaching part 52.

The displacement detection unit 61 serves as a displacement sensor which detects the three-dimensional displacement of the pen tip 51. The displacement detection unit 61 may detect the displacement of the pen tip 51 which is displaced in directions of the X axis, the Y axis and the Z axis with respect to the pen body part 53, for example, when the axial direction of the pen body part 53 is set to be the Z axis, and the X axis and the Y axis are disposed to be orthogonal to the Z axis. As the displacement sensor, for example, a pressure sensor may be used, and when a user holds the pen body part 53 of the touch pen 50 and the pen tip 51 is touched to the display screen 10, even though the pen body part 53 is inclined or directed in any direction, the displacement sensor may detect the displacement of the pen tip 51.

Further, the displacement detection unit 61 detects the pen down representing that the pen tip 51 is touched to the display screen 10. As illustrated in FIG. 4, the effect of hovering which erroneously detects the touch before the pen tip 51 of the touch pen 50 is touched to the display screen 10 may be removed by detecting the pen down.

When a user approaches the touch pen 50 to the display screen 10, the control unit 24 detects whether the light shielding object is present. When the pen down is detected by touching the pen tip 51 of the touch pen 50 to the display screen 10, the positional information representing where the pen tip 51 (the light shielding object) is present at any coordinate of the display screen 10 is transmitted to the PC 200, and an instruction for drawing an image (for example, a point image and a line image of the writing brush shape) is transmitted to the PC 200 corresponding to the detection of the pen down. Further, the PC 200 transmits the image signal for drawing an image of the writing brush shape at the coordinates in which the pen down is present to the touch panel apparatus 100.

The reference direction detection unit 62 serves as the reference sensor to detect the reference direction on the display screen 10. As the reference direction detection unit 62, for example, an accelerator sensor, a geomagnetic sensor and the like may be used.

The angle calculation unit 63 has a function as a calculation unit to calculate an angle between a direction in which the direction of the pen tip 51 is projected on the display screen 10 when the pen tip 51 is touched to the display screen 10 and the reference direction on the display screen 10. When a user touches the pen tip 51 to the display screen 10 in the state in which the touch pen 50 is inclined with respect to the display screen 10 in any direction, the direction of the touch. pen 50 when the entire touch pen 50 is projected on the display screen 10, that is, the direction of the pen tip 51 becomes one direction on the display screen 10. The angle calculation unit 63 calculates an angle between the corresponding one direction and the reference direction on the display screen 10. By this, in which direction the pen tip 51 is inclined with respect to the reference direction may be specified by the angle.

In more detail, the angle calculation unit 63 calculates the above-described angle based on the displacement detected by the displacement detection unit 61 and the reference direction detected by the reference direction detection unit 62. By this, when a user holds the pen body part 53 of the touch pen 50 and the pen tip 51 is touched to the display screen 10, even though the pen body part 53 is inclined or directed in any direction, the angle between the direction on the display screen 10 with respect to the direction of the pen tip 51 and the reference direction may be obtained based on the displacement and the reference direction of the pen tip 51.

The drawing direction determination unit 64 has a function as a determination unit to determine the direction of the image of the writing brush shape which is drawn depending on the angle calculated by the angle calculation unit 63. When a user starts to write the image of the writing brush shape, generally, a width of the image (for example, like a small point image) is small when the brush is touched to the drawing surface and the width of the image is gradually increased (for example, like a large point image) as the brush gradually moves. By this, the moving direction of the brush of a user (the moving direction of the pen tip of the touch pen) may be specified by determining the direction of the image of the writing brush shape (the image drawn with the brush) depending on the angle calculated by the angle calculation unit 63. Thereby, when a user writes characters with the touch pen 50, the direction of the image of the writing brush shape drawn is different depending on the direction in which a user starts to write characters with the touch pen 50, and therefore the writing-out portion of the writing brush may be drawn as intended by a user.

The communication unit 65 transmits the information of the drawing direction determined by the drawing direction determination unit 64 and the pen down signal representing the pen down detection to the receiving unit 28. As the communication unit 65, for example, an ultrasonic speaker, a wireless module or the like may be used.

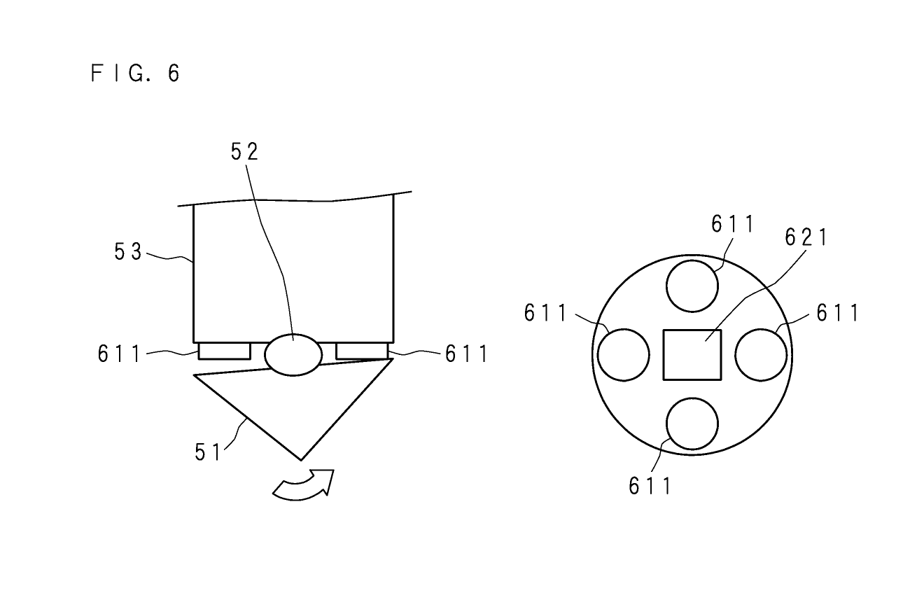

Next, a detailed example of the structure of the touch pen 50 will be described. FIG. 6 is a schematic diagram illustrating a first example of the touch pen 50 according to the embodiment of the present invention. As illustrated in FIG. 6, the touch pen 50 includes a conical pen tip 51 and a cylindrical pen body part 53, and the pen tip 51 is attached (connected) to the pen body part 53 by a ball joint 52 so that the tip end of the pen tip 51 is freely inclined (three-dimensional displacement may be made).

An accelerator sensor 621 (for example, three-axis accelerator sensor) as the reference direction detection unit 62 is fixed to a central portion of an end face of the pen body part 53 facing the pen tip 51, and pressure sensors 611 as the displacement detection unit 61 are fixed around the accelerator sensor 621. Further, in the example of FIG. 6, four pressure sensors 611 are disposed around the accelerator sensor 621 at an equal interval, but the number of pressure sensors 611 is not limited to four.

As illustrated in FIG. 6, a user touches the pen tip 51 of the touch pen 50 to the display screen 10, and thus the pen tip 51 is inclined in a direction represented by an arrow illustrated in FIG. 6. As the pen tip 51 is inclined in any direction, the pressure applied to four pressure sensors 611 is changed, and each pressure sensor 611 outputs a voltage depending on the pressure applied thereto.

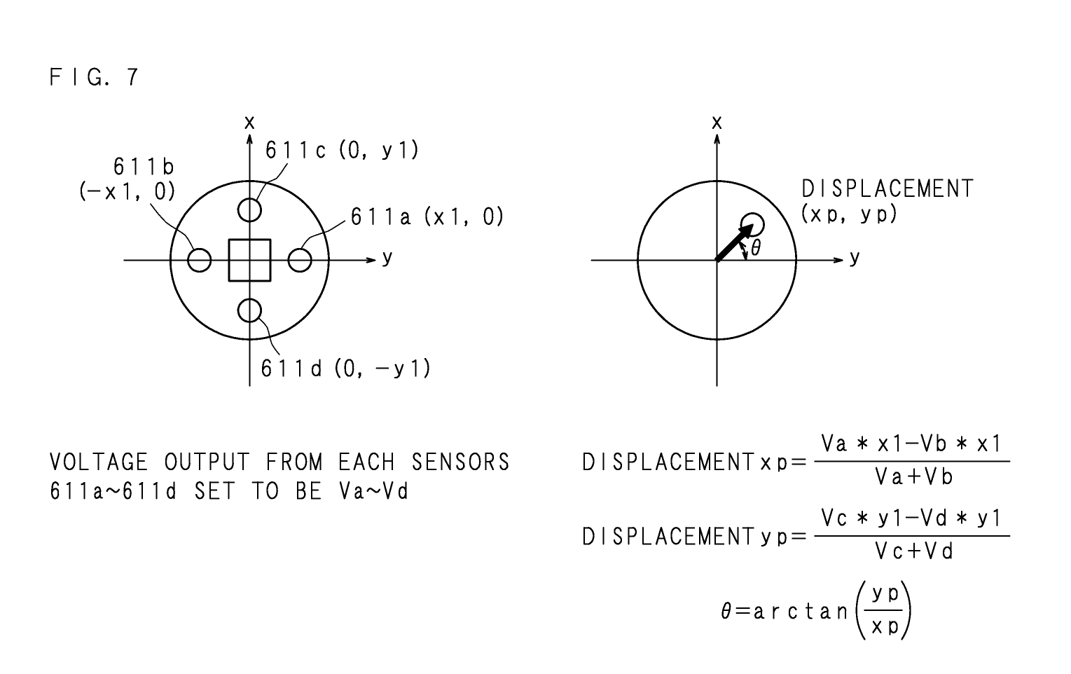

FIG. 7 is a diagram describing an example of calculation of an angle by the touch pen 50 of the first example. As illustrated in FIG. 7, the four pressure sensors 611 are provided with the XY coordinates so that they are positioned on the X axis and the Y axis orthogonal to each other. The surface defined by the XY coordinates becomes a surface parallel with the display screen 10. In the example of FIG. 7, a pressure sensor 611a is located at coordinates (x1 and 0), a pressure sensor 611b is located at coordinates (−x1 and 0), a pressure sensor 611c is located at coordinates (0 and y1), and a pressure sensor 611d is located at coordinates (0 and −y1). Further, the voltage output from each of the pressure sensors 611a to 611d are set to be Va, Vb, Vc and Vd, respectively.

The pressure sensor 611 uses, for example, a polymer thick film (PTF), and may use properties wherein a resistance value is reduced depending on the pressure applied thereto to obtain the voltage depending on the pressure.

In this case, a displacement xp on the XY coordinates of the pen tip 51 may be obtained by Equation (Va*x1−Vb*x1)/(Va+Vb), and a displacement yp on the XY coordinates of the pen tip 51 may be obtained by Equation (Vc*y1−Vd*y1)/(Vc+Vd). Further, an angle θ between the X axis direction and the direction of the displacement may be obtained by Equation arctan (yp/xp).

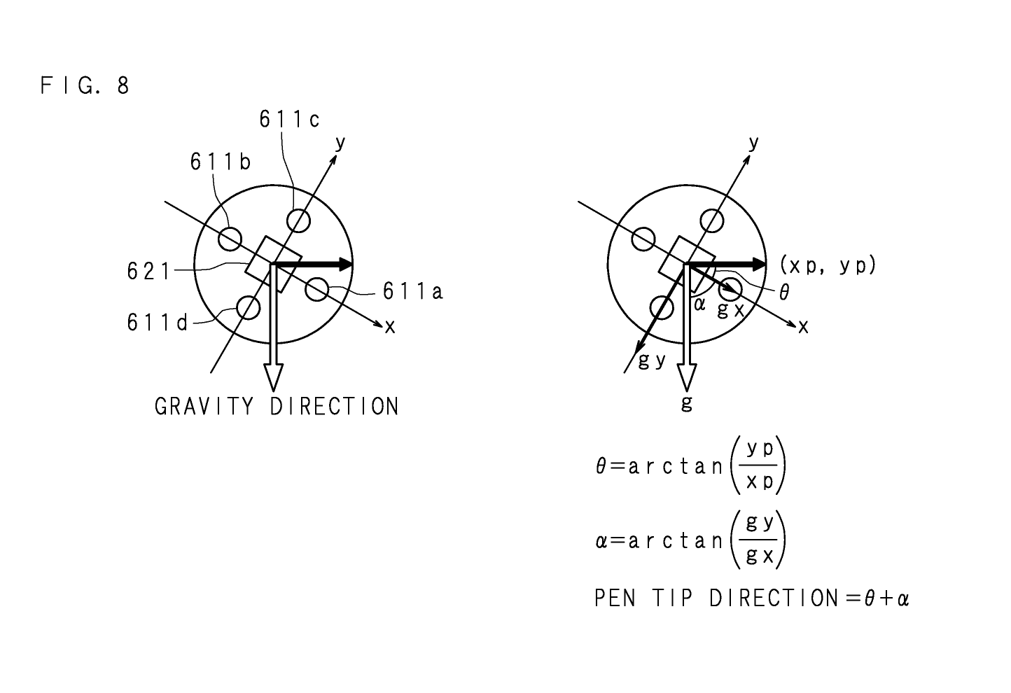

FIG. 8 is a diagram describing an example of calculation of an angle by the touch pen 50 of the first example when considering a reference direction. In the example of FIG. 8, for example, when the display screen 10 of the touch panel apparatus 100 is an upright type, that is, when the display screen 10 may be vertically disposed along a vertical plane, a gravity direction may be used as the reference direction of the display screen 10. In the example of FIG. 8, the inclination of the pen tip 51 is detected by the pressure sensors 611 and the position of the touch pen 50 (pen body part 53) is detected by the accelerator sensor 621. By this, it is possible to specify the direction in which the direction of the pen tip 51 is directed on the display screen 10.

The Z-axis direction of the accelerator sensor 621 is set to be the axial direction of the pen body part 53, and the accelerator sensor 621 is disposed in advance so that the X-axis direction and the Y-axis direction are on the end face of the pen body part 53 facing the pen tip 51. Further, the pressure sensors 611 are disposed on the X axis and the Y axis of the accelerator sensor 621. By the above-described disposition, the gravity direction detected by the accelerator sensor 621 and the positional relationship of the pressure sensor 611 are defined.

When the displacement of the pen tip 51 detected by the pressure sensors 611 is set to be xp and yp, the angle θ formed by the displacement direction with respect to the X-axis direction is the same as the example of FIG. 7, and may be obtained by Equation arctan (yp/xp).

When the pen body part 53 is substantially vertical to the display screen 10 (in the case in which the touch panel apparatus 100 is an upright type, when a user holds the touch pen 50 and touches the display screen 10, it may be considered that the pen body part 53 is substantially vertical to the display screen 10), the component of the accelerator sensor 621 in the Z-axis direction may be assumed to be substantially 0. Components gx and gy in the X-axis and Y-axis directions of a g vector in the gravity direction are obtained based on the output of the accelerator sensor 621. In this case, an angle a between the X-axis direction and the gravity direction (direction of the g vector) may be obtained by Equation arctan (gy/gx). Therefore, the angle with respect to the reference direction (gravity direction) of the pen tip 51 may be obtained by Equation (θ+α).

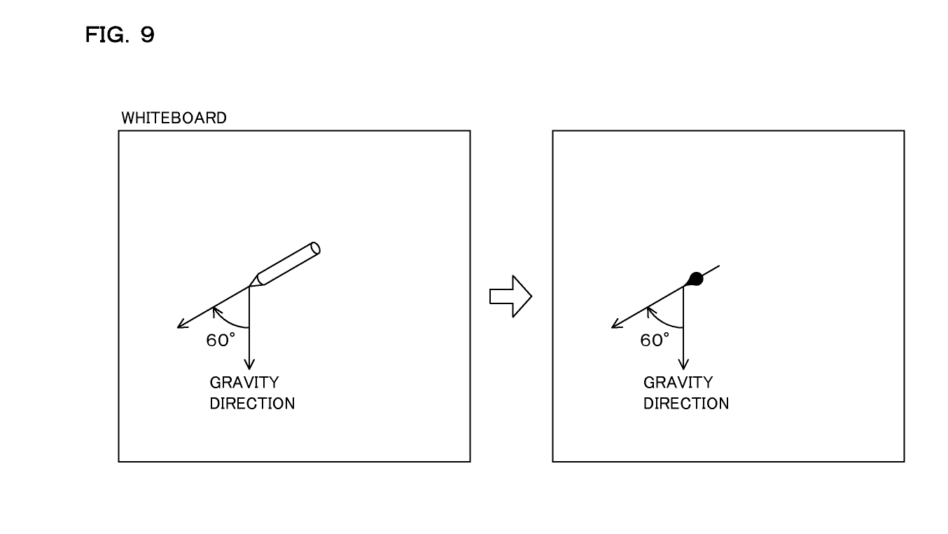

FIG. 9 is a diagram describing an example of a drawing of the image of the writing brush shape by the touch pen 50 of the first example based on the gravity direction. The example of FIG. 9 illustrates a whiteboard in which the display screen 10 is vertically disposed. The left drawing of FIG. 9 illustrates an example of an appearance of the touch pen 50 touched to the display screen 10 and the right drawing of FIG. 9 illustrates an example of the image of the writing brush shape drawn on the display screen 10.

As illustrated in FIG. 9, the angle between the direction of the pen tip 51 and the gravity direction which is the reference direction is set to be, for example, 60°. In this case, the image of the writing brush shape is formed in a narrow width toward the direction of the pen tip 51 forming an angle of 60° with respect to the gravity direction, and is formed in a wide width toward the direction of 180° with respect to the moving direction of the pen tip 51, that is, the direction of the pen tip 51.

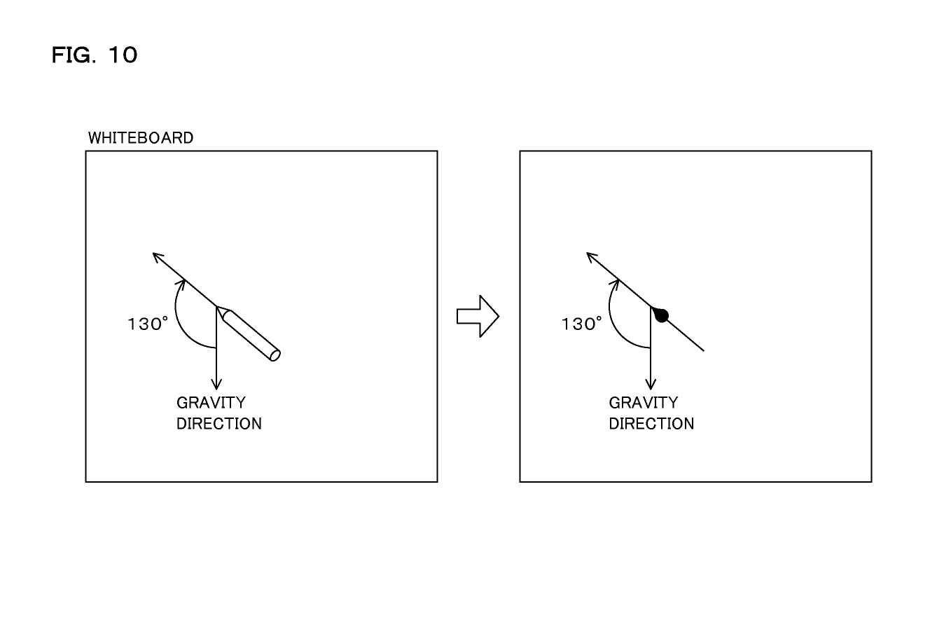

FIG. 10 is a diagram describing another example of a drawing of the image of the writing brush shape by the touch pen 50 of the first example based on the gravity direction. The example of FIG. 10 illustrates a whiteboard in which the display screen 10 is vertically disposed. The left drawing of FIG. 10 illustrates an example of an appearance of the touch pen 50 touched to the display screen 10 and the right drawing of FIG. 10 illustrates an example of the image of the writing brush shape drawn on the display screen 10.

As illustrated in FIG. 10, the angle between the direction of the pen tip 51 and the gravity direction which is the reference direction is set to be, for example, 130°. In this case, the image of the writing brush shape is formed in a narrow width toward the direction of the pen tip 51 forming an angle of 130° with respect to the gravity direction. Further, the width of the drawn image of the writing brush shape is thickened toward the direction of 180° with respect to the moving direction of the pen tip 51, that is, the direction of the pen tip 51.

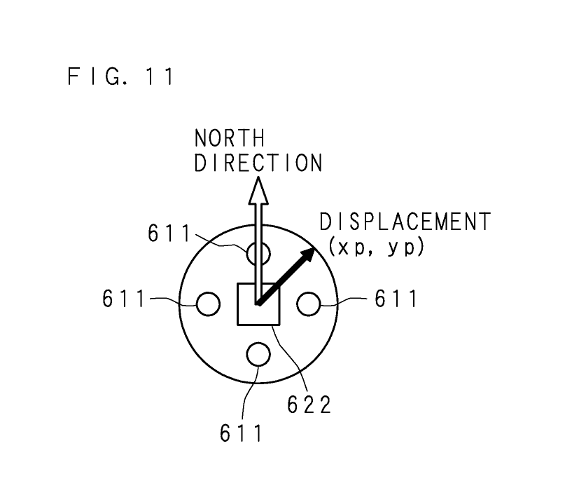

FIG. 11 is a diagram describing another example of calculation of an angle by the touch pen 50 of the first example when considering a reference direction. In the example of FIG. 11, for example, when the display screen 10 of the touch panel apparatus 100 is a table type, that is, when the display screen 10 is horizontally disposed in a horizontal direction, as the reference direction of the display screen 10, a geomagnetic direction (an earth's magnetic field) may be used. The geomagnetic direction as the reference direction may be set to be, for example, the north direction, but is not limited to the north direction. For example, the geomagnetic direction may be east, west, or south direction.

The inclination of the pen tip 51 is detected by the pressure sensors 611 and its own position of the touch pen 50 (the pen body part 53) is detected by a geomagnetic sensor 622. Further, the calculation of the angle by the direction of the pen tip 51 with respect to the reference direction is the same as the example of FIG. 8, and therefore a description thereof will be omitted. Further, in the case of the table type, the body side (the display unit side) of the touch panel apparatus 100 is also provided with the geomagnetic sensor to detect the reference direction. By this, it is possible to specify the direction in which the direction of the pen tip 51 is directed on the display screen 10.

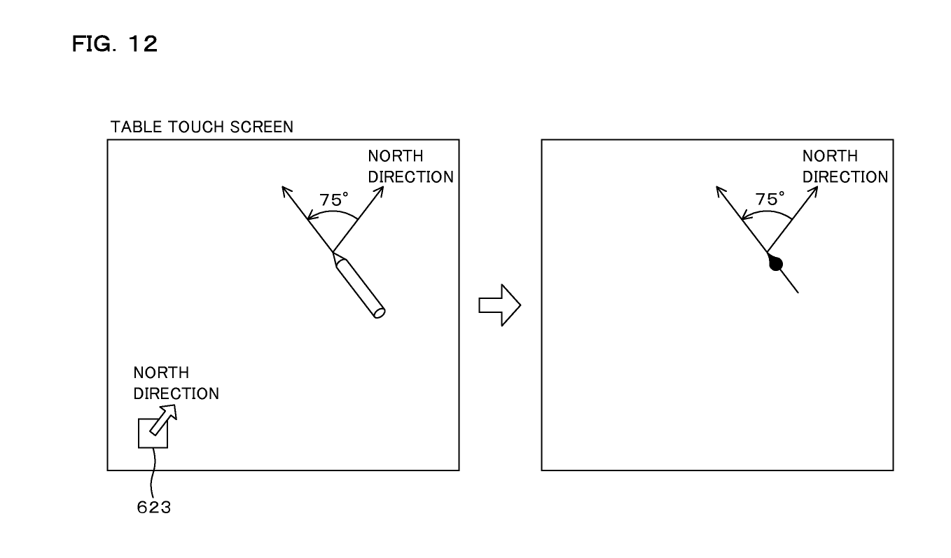

FIG. 12 is a diagram describing an example of a drawing of the image of the writing brush shape by the touch pen 50 of the first example based on the north direction. The example of FIG. 12 illustrates a table touch screen in which the display screen 10 is horizontally disposed. The left drawing of FIG. 12 illustrates an example of an appearance of the touch pen 50 touched to the display screen 10 and the right drawing of FIG. 12 illustrates an example of the image of the writing brush shape drawn on the display screen 10. A geomagnetic sensor 623 for detecting the north direction which is the reference direction is provided at an appropriate region of the touch panel apparatus 100. As the geomagnetic sensor 623, the same one as the geomagnetic sensor 622 may be used.

As illustrated in FIG. 12, the angle between the direction of the pen tip 51 and the north direction which is the reference direction is set to be, for example, 75°. In this case, the image of the writing brush shape is formed in a narrow width toward the direction of the pen tip 51 forming an angle of 75° with respect to the north direction, and is formed in a wide width toward the direction of 180° with respect to the moving direction of the pen tip 51, that is, the direction of the pen tip 51.

As illustrated in FIGS. 9, 10, and 12, by changing the direction of the drawing of the image of the writing brush shape according to the direction of the pen tip 51 when the pen tip 51 of the touch pen 50 is touched to the display screen 10, similar to writing characters with the brush, a direction of brush hairs is reproduced, and thus the image of the writing brush shape may be reproduced more realistically and the same effect as writing characters with a brush may be obtained.

Further, the PC 200 as the drawing unit draws the image of the writing brush shape which is formed in a wide width toward the direction determined by the drawing direction determination unit 64, on the display screen 10. That is, the image is drawn in a narrow width at the early stage of the writing-out of the writing brush and is drawn in a gradually wide width as the pen tip moves. Therefore, even when a user moves the pen tip in any direction, the image of the writing brush shape having a changing width depending on the moving direction of the pen tip may be drawn.

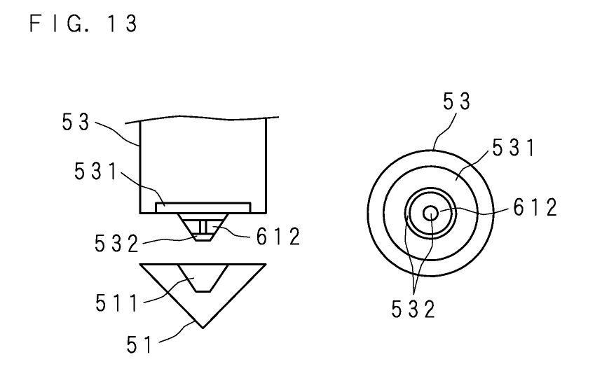

FIG. 13 is a schematic diagram illustrating a second example of the touch pen 50 according to the embodiment of the present invention. As illustrated in FIG. 13, the pen tip 51 is formed in a conical shape, and as a material of the pen tip 51, a magnetic material such as a magnet may be used. A housing part 511 which is a space formed in a circular truncated cone shape is formed at an end space of the pen tip 51 facing the pen body part 53.

An annular plate part 531 made of a ferromagnetic substance such as iron is buried into the end face of the pen body part 53 facing the pen tip 51. Further, a cone part, 532 having a circular truncated cone shape is provided on the central portion of the end face. (the central portion of the plate part 531) of the pen body part 53 facing the pen tip 51. A band-shaped pressure sensor 612 is provided on a circumferential surface of the cone part 532. The cone part 532 of the pen body part 53 is loosely housed in the housing part 511 of the pen tip 51 so that a pressure detected by the pressure sensor 612 becomes zero (0). Further, for example, a gap ranging from 10 μm to 100 μm is formed between a surface of the pressure sensor 612 and the housing part 511.

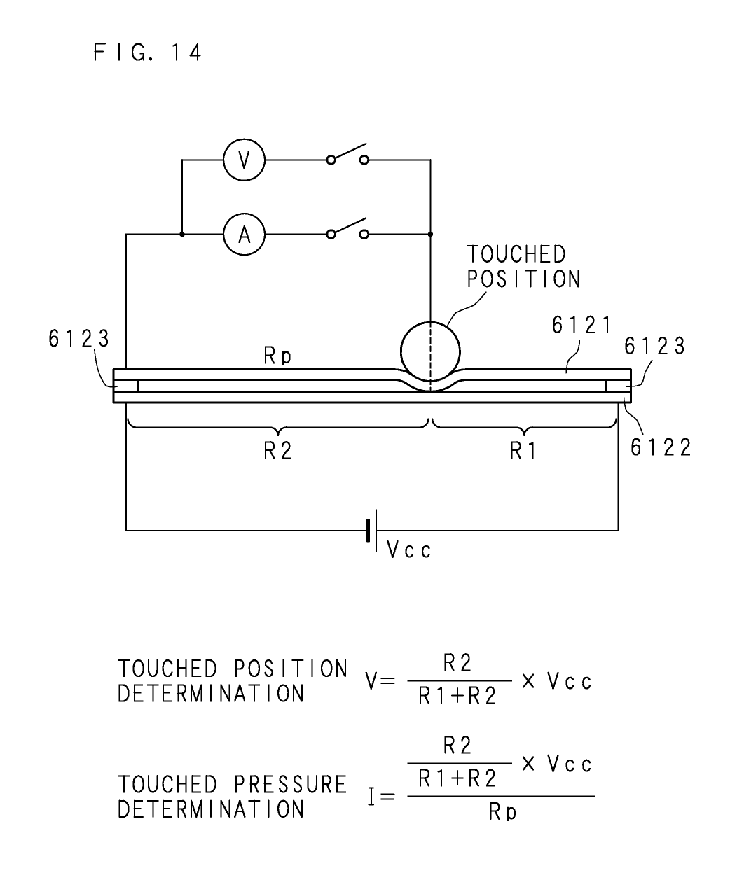

FIG. 14 is a schematic diagram illustrating an example of the pressure sensor 612 of the touch pen 50 of the second example. As illustrated in FIG. 14, the pressure sensor 612 has a structure in which a band-shaped conductive film 6121 and a conductive face of a resistive film 6122 are disposed to face each other and both ends of the conductive film 6121 and the resistive film 6122 are bonded to each other by a non-conductive adhesive 6123. A spaced dimension between the conductive film 6121 and the resistive film 6122 ranges from 1 μm, to 1 mm, for example.

The conductive film 6121 is an electrode formed by a thin metal (for example, aluminum or the like) laminated on a polyethylene terephthalate (PET) film, for example. The resistive film 6122 is formed by laminating a carbon film on the PET film and the entire resistive film 6122 is a conductive sheet. As a non-conductive adhesive 6123, for example, a rubber-based adhesive, vinyl-based adhesive and the like having flexibility may be used.

When the pen tip 51 is inclined by touching the pen tip 51 to the display screen 10, it is assumed that the corresponding region of the pressure sensor 612 is touched to the housing part 511. As illustrated in FIG. 14, when a pressure is applied to the conductive film 6121, the conductive film 6121 is bent and contacts to the resistive film 6122. In this case, the resistive film 6122 is divided into a portion of a resistance value R1 and a portion of a resistance value R2 depending on the portion of the resistive film 6122 to which the conductive film 6121 is contacted. Therefore, the determination of the touched region may be performed by a voltage V which is obtained by dividing a voltage Vcc by the resistance values R1 and R2. The voltage V may be obtained by Equation R2×Vcc/(R1+R2).

Further, a resistance value Rp of the conductive film 6121 is reduced in proportion to the pressure applied to the conductive film 6121. Therefore, the determination of the touched pressure may be performed by a current I flowing in the conductive film 6121 which is obtained by dividing the voltage V at the touched region by the resistance value Rp thereof. The current I may be obtained by Equation R2×Vcc/(R1+R2)/Rp.

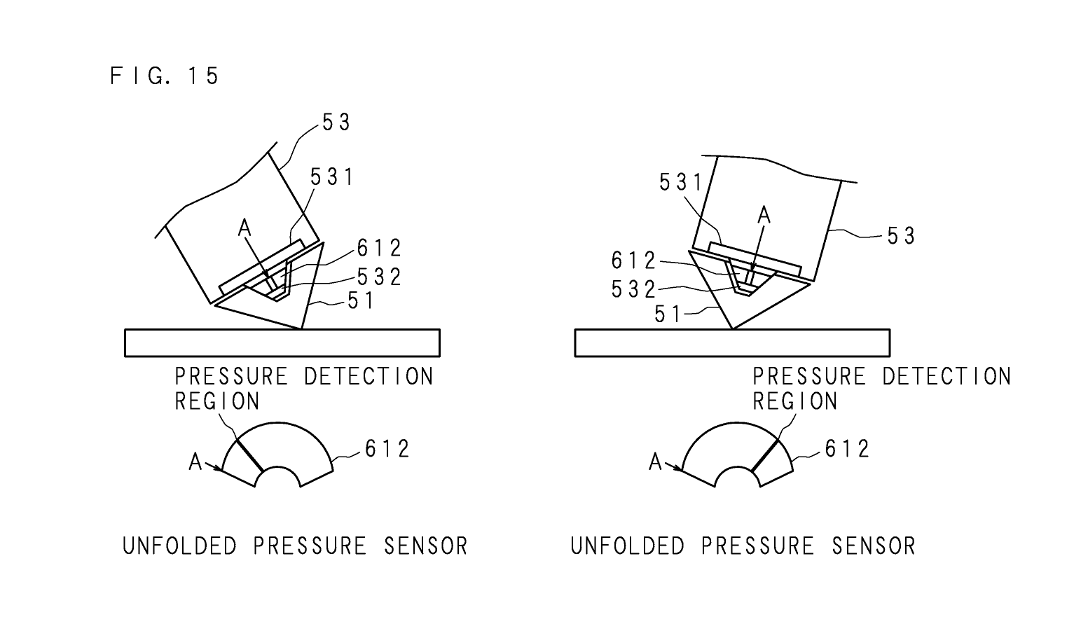

FIG. 15 is a diagram describing an example of calculation of an angle by the touch pen 50 of the second example. As illustrated in FIG. 15, when the pen tip 51 is touched to the display screen 10 in the state in which the pen tip 51 is inclined, one region of the housing part 511 of the pen tip 51 contacts to a circumferential surface of the cone part 532 of the pen body part 53. The pressure sensor 612 is in surface contact, but the pressure sensor 612 detects a point having the smallest resistance value as a load point, and therefore a contact point becomes a point to which a maximum load is applied.

In this case, as illustrated in FIG. 15, if the band-shaped pressure sensor 612 is considered to be unfolded, a pressure detection region is formed in a linear shape in a width direction and a contact region may be detected by a distance from a point represented by a symbol A. For example, the accelerator sensor or the geomagnetic sensor is mounted on the region represented by the symbol A, and the distance from the symbol A is associated with the inclination of the pen tip 51, whereby the inclination of the pen tip 51 may be obtained. Further, similar to the case of the first example, the angle by the direction of the pen tip 51 with respect to the reference direction may be obtained.

As described above, the contact of the pen tip to the display screen is detected by the pressure sensor 612, and therefore the detection precision of the angle may be increased compared with the case in which light or magnetic force is detected. Further, the band-shaped pressure sensor 612 is disposed on the circumferential surface of the cone part 532 over 360°, and therefore the inclination of the pen tip 51 may be detected with a high degree of accuracy throughout 360°. In addition, by using only one pressure sensor 612, the detection error between the sensors does not occur compared with the case of using the plurality of sensors. Further, the angle by the direction of the pen tip 51 with respect to the reference direction may be obtained only by detecting the distance from the point represented by the symbol A, and therefore a complicated operation is unnecessary and the configuration is simple.

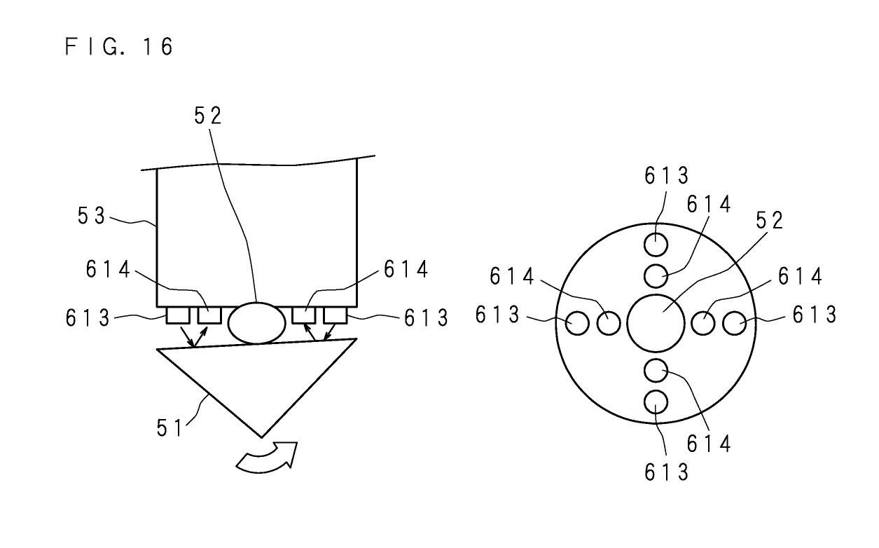

FIG. 16 is a schematic diagram illustrating a third example of the touch pen 50 according to the embodiment of the present invention. As illustrated in FIG. 16, the touch pen 50 includes the conical pen tip 51 and the cylindrical pen body part 53, and the pen tip 51 is attached (connected) to the pen body part 53 by the ball joint 52 so that the tip end of the pen tip 51 is freely inclined (three-dimensional displacement may be made).

The accelerator sensor 621 (not illustrated) as the reference direction detection unit 62 is fixed to the central portion of the end face of the pen body part 53 facing the pen tip 51 and sets of a light source 613 and an optical sensor 614 as the displacement detection unit 61 are fixed around the accelerator sensor 621. Further, the example of FIG. 16 illustrates the configuration that four sets of the light sources 613 and the optical sensors 614 are disposed around the accelerator sensor 621 at an equal interval, but the number of sets of the light sources 613 and the optical sensors 614 is not limited to four.

In the light source 613 and the optical sensor 614 included in each set, the light emitted from the light source 613 is reflected from the end face of the pen tip 51 facing the pen body part 53, and the reflected light is detected by the optical sensor 614. The inclination of the pen tip 51 may be obtained depending on a light quantity detected by the optical sensor 614. For example, as the end face of the pen tip 51 facing the pen body part 53 approaches the optical sensor 614, the reflected light is strong and the voltage output from the optical sensor 614 is increased. When the pen tip 51 is inclined, the reflected light received by each optical sensor 614 is changed. Therefore, the inclination of the pen tip 51 in any direction may be obtained by the disposition of the plurality of sets of light sources 613 and optical sensors 614. Further, similar to the case of the first example, the angle by the direction of the pen tip 51 with respect to the reference direction may be obtained.

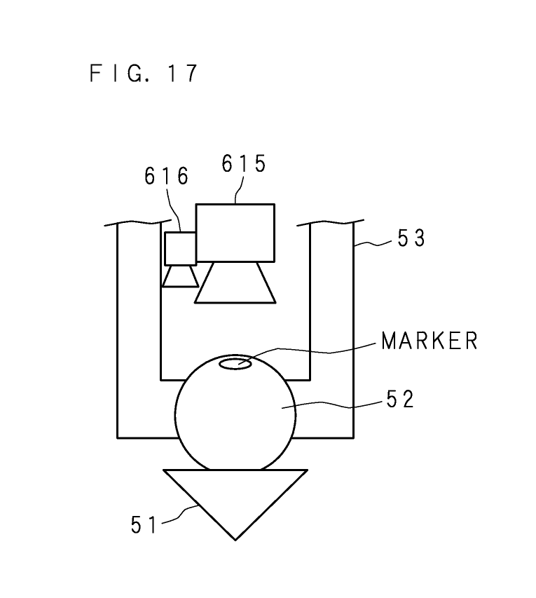

FIG. 17 is a schematic diagram illustrating a fourth example of the touch pen 50 according to the embodiment of the present invention. As illustrated in FIG. 17, the touch pen 50 includes the conical pen tip 51 and the cylindrical pen body part 53, and the pen tip 51 is attached (connected) to the pen body part 53 by the spherical ball joint 52 so that the tip end of the pen tip 51 is freely inclined (three-dimensional displacement may be made).

The ball joint 52 includes a marker, and a lighting part 616 for photographing the marker and a camera 615 photographing the marker are disposed in the body part.

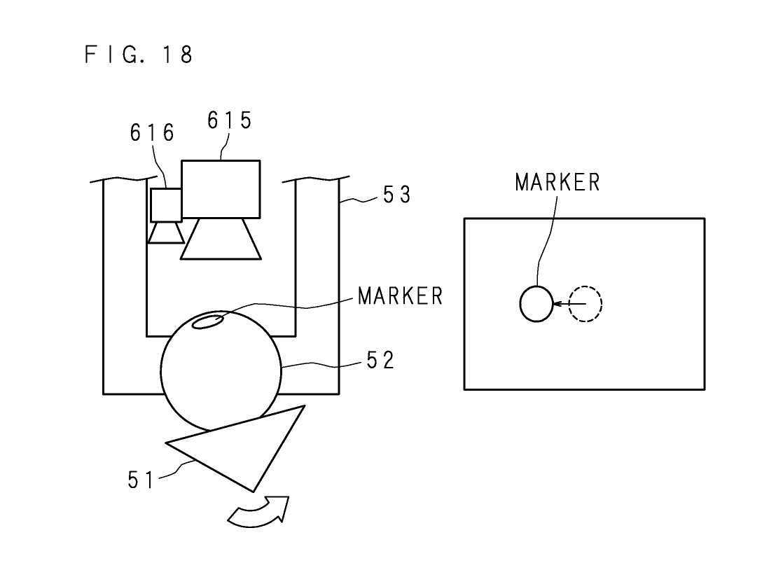

FIG. 18 is a diagram describing an example of calculation of an angle by the touch pen 50 of the fourth example. When the pen tip 51 is touched to the display screen 10 in the state in which the pen tip 51 is inclined, the marker moves in a direction opposite to the direction in which the pen tip 51 is inclined. Therefore, the inclination direction of the pen tip 51 may be detected by detecting the position (the moving direction) of the marker on the image obtained by photographing an image by the camera 615. Further, similar to the case of the first example, the angle by the direction of the pen tip 51 with respect to the reference direction may be obtained.

The inclination of the pen tip 51 may be understood as moving pictures. Therefore, even when a micro angle which is difficult to be detected by a method for detecting reflected light or another sensor type detecting system, or the inclination of the pen tip 51 is continuously changed, the inclination may be continuously detected by accurately following the operation of the pen tip 51.

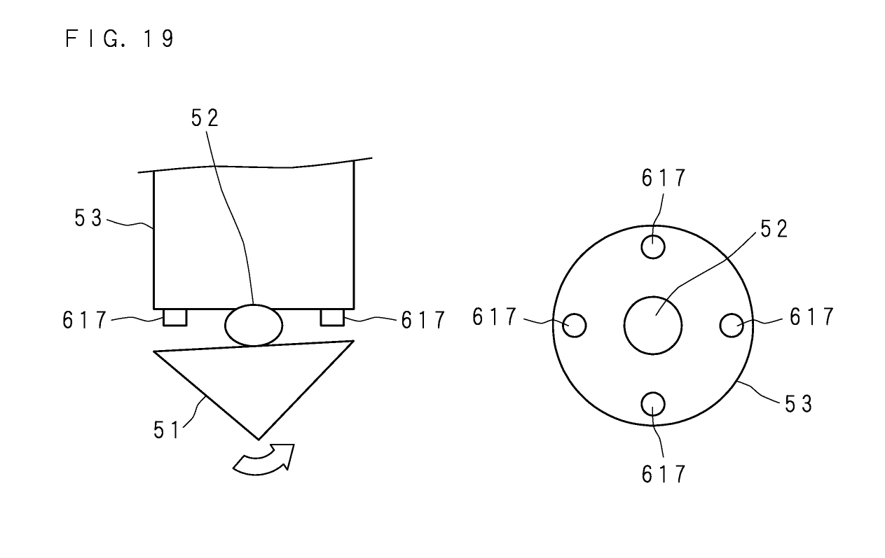

FIG. 19 is a schematic diagram illustrating a fifth example of the touch pen 50 according to the embodiment of the present invention. As illustrated in FIG. 19, the touch pen 50 includes the conical pen tip 51 made of a magnetic substance such as a magnet and the cylindrical pen body part 53, and the pen tip 51 is attached (connected) to the pen body part 53 by the ball joint 52 so that the tip end of the pen tip 51 is freely inclined (three-dimensional displacement may be made). Further, the entire pen tip 51 may made of a magnet, or only the end face of the pen tip 51 facing the pen body part 53 may be a magnet or the magnet may be fixed to the corresponding end face.

The accelerator sensor 621 (not illustrated) as the reference direction detection unit (32 is fixed to the central portion of the end face of the pen body part 53 facing the pen tip 51 and Hall elements 617 as the displacement detection unit 61 are fixed around the accelerator sensor 621. Further, the example of FIG. 19 illustrates a configuration in which four Hall elements 617 are disposed around the accelerator sensor 621 at an equal interval, but the number of Hall elements 617 is not limited to four.

Each Hall element 617 may output a voltage in proportion to a magnetic flux density due to a magnetic flux from the pen tip 51.

When the pen tip 51 is inclined, the pen tip 51 approaches any one of the Hall elements 617, and therefore the voltage output from the corresponding Hall element 617 is increased. Similar to the case of the first example, the displacement (in which direction the pen tip is inclined) of the pen tip 51 is detected by detecting the voltage output from each Hall element 617 to obtain the angle by the direction of the pen tip 51 with respect to the reference direction.

When the Hall element 617 is used, a measure to remove the effect of disturbance and the like is unnecessary. Further, only the

Hall element 617 is driven, and therefore the power consumption may be reduced compared with the case in which the reflected light is detected.

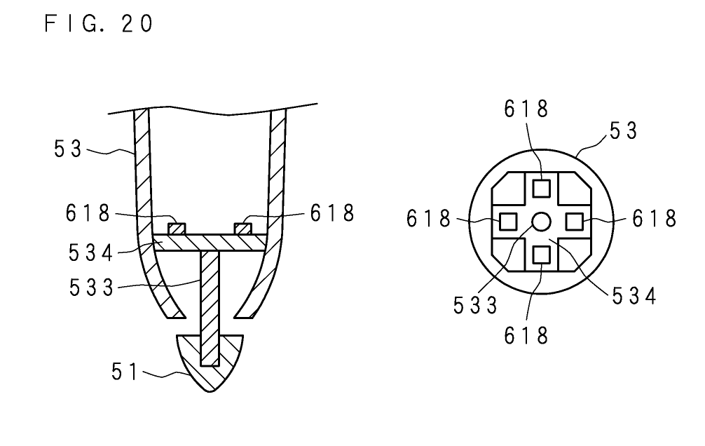

FIG. 20 is a schematic diagram illustrating a sixth example of the touch pen 50 according to the embodiment of the present invention. As illustrated in FIG. 20, the touch pen 50 includes the conical pen tip 51 and the cylindrical pen body part 53. A cruciform plane plate 534 is fixed inside the pen body part 53, a pillar-shaped support part 533 is erected from a central portion of the plane plate 534, and a tip end of the support part 533 is fixed to the pen tip 51. Therefore, the tip end of the pen tip 51 may be freely inclined (three-dimensional displacement may be made).

The cruciform plane plate 534 includes four strain gauges 618 as the displacement detection unit 61 to surround the support part 533. Further, the shape of the plane plate 534 is not limited to a cruciform shape but may be changed according to the number of strain gauges.

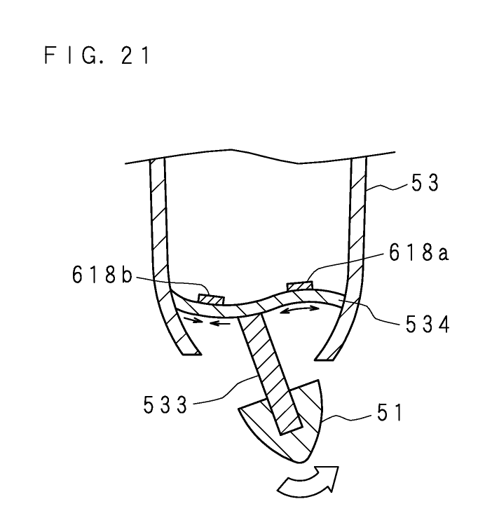

FIG. 21 is a diagram describing an example of calculation of an angle by the touch pen 50 of the sixth example. As illustrated in FIG. 21, when the pen tip 51 is touched to the display screen 10 in the state in which the pen tip 51 is inclined, the plane plate 534 is bent through the support part 533 fixed to the pen tip 51. The bending of the plane plate 534 is detected by each strain gauge 618. In more detail, the strain gauge 618 is a resistance body and for example, as illustrated in FIG. 21, when a strain gauge 618a extends as represented by an arrow and a strain gauge 618b is contracted as represented by an arrow, the resistance values of each strain gauge are changed.

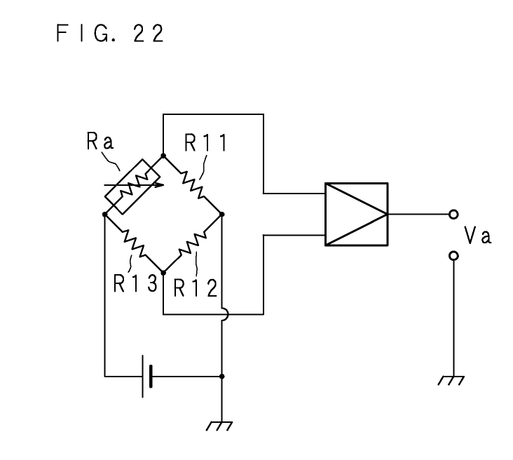

FIG. 22 is a diagram describing an example of a method of detecting a strain of the strain gauge 618 of the sixth example. As illustrated in FIG. 22, for each strain gauge, a bridge is configured of the strain gauge (resistance value Ra) and other resistors R11, R21 and R13, and a differential voltage Va is detected by an amplifier. Similar to the case of the first example, the displacement (in which direction the pen tip is inclined) of the pen tip 51 is detected by detecting the differential voltage Va obtained by each strain gauge to obtain the angle by the direction of the pen tip 51 with respect to the reference direction.

The bending of the plane plate 534 is detected by the strain gauge 618, and therefore sensitivity and precision may be increased compared with the case in which light or magnetic force is detected. Further, the bending of the plane plate 534 to which the pen tip 51 is fixed is directly detected, and therefore the strain may be detected with increased detection sensitivity, only by a weak force applied thereto.

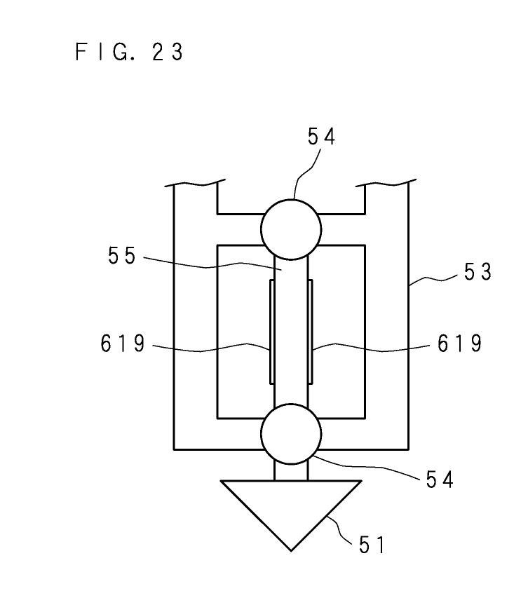

FIG. 23 is a schematic diagram illustrating a seventh example of the touch pen 50 according to the embodiment of the present invention. As illustrated in FIG. 23, the touch pen 50 includes the conical pen tip 51 and the cylindrical pen body part 53. Two ball joints 54 are disposed inside of the pen body part 53 to he spaced apart from each other at an interval of appropriate length (for example, about 10 cm). A pillar-shaped holding part 55 made of a flexible material (for example, silicon rubber, urethane rubber or the like) such as rubber is disposed between the two ball joints 54. Bending sensors 619 are provided on a side (the circumferential surface) of the holding part 55. At least three bending sensors 619 are provided around the holding part 55. The bending sensor 619 may be used as a strain gauge in which the resistance value is changed in response to the bending thereof.

The ball joint 54 disposed on the pen tip 51 side of the pen body part 53 connects the pen tip 51 with the pen body part 53 so that the tip end of the pen tip 51 is freely inclined (three-dimensional displacement may be made).

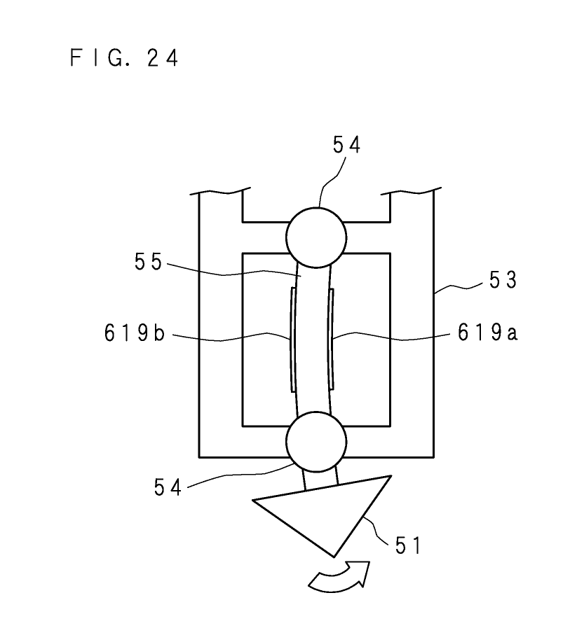

FIG. 24 is a diagram describing an example of calculation of an angle by the touch pen 50 of the seventh example. As illustrated in FIG. 24, when the pen tip 51 is touched to the display screen 10 in the state in which the pen tip 51 is inclined, the holding part 55 is bent. The bending of the holding part 55 is detected by the bending sensors 619. In more detail, the bending sensors 619 are a resistor body, and for example, as illustrated in FIG. 24, when a bending sensor 619a is contracted and a bending sensor 619b extends, the resistance values of each bending sensor are changed. Similar to the case of the first example, the displacement (in which direction the pen tip is inclined) of the pen tip 51 is detected by detecting (for example, detecting the resistance value by converting the resistance value into a voltage value) the resistance values of each bending sensor 619 to obtain the angle by the direction of the pen tip 51 with respect to the reference direction.

The holding part 55 made of a flexible material is provided with the bending sensors 619 to reproduce the resistance force of the writing brush such as when writing characters or the like with the writing brush, and more realistically reproduce characters or the like which are written with the writing brush.

The touch panel apparatus (100) of the present embodiment includes the display screen (10), and is configured to detect a position when the pen tip (51) of the touch pen (50) is touched to the display screen, and draw an image of the writing brush shape at the detected position, and the touch panel apparatus characterized by including: the calculation unit (63) configured to calculate an angle between a direction in which a direction of the pen tip is projected on the display screen when the pen tip of the touch pen is touched to the display screen and a reference direction on the display screen; and the determination unit (64) configured to determine a direction of the image of the writing brush shape which is drawn depending on the angle calculated by the calculation unit.

According to the present embodiment, the calculation unit (63) calculates the angle between the direction in which the direction of the pen tip is projected on the display screen when the pen tip (51) is touched to the display screen (10) and the reference direction on the display screen. When a user touches the pen tip to the display screen in the state in which the touch pen (50) is inclined with respect to the display screen in any direction, the direction of the touch pen when the entire touch pen is projected to the display screen, that is, the direction of the pen tip is one direction on the display screen. The calculation unit calculates the angle between the one direction and the reference direction on the display screen. By this, in which direction the pen tip is inclined with respect to the reference direction may be specified by the angle.

The determination unit (64) determines the direction of the image of the writing brush shape which is drawn depending on the angle calculated by the calculation unit. When a user starts to write the image of the writing brush shape, generally, a width of the image (for example, like a small point image) is small when the brush is touched to the drawing surface and the width of the image is gradually increased (for example, like a large point image) as the brush gradually moves. Therefore, the moving direction (the moving direction of the pen tip of the touch pen) of the brush of a user may be specified by determining the direction of the image of the writing brush shape (the image drawn with the brush) depending on the angle calculated by the calculation unit. Thereby, when a user writes characters with the touch pen, the direction of the image of the writing brush shape drawn is different depending on the direction in which a user starts to write characters with the touch pen, and therefore the writing-out portion of the writing brush may be drawn as intended by a user.

The touch panel apparatus of the present embodiment is characterized in that, the touch pen includes the pen body part (53) having the attaching part (52) to which the pen tip is attached, wherein the pen tip is capable of three-dimensionally displaced around the attaching part, and the pen body part includes: the reference sensor (62) configured to detect a reference direction on the display screen; and the displacement sensor (61) configured to detect a three-dimensional displacement of the pen tip, wherein the calculation unit (63) is configured to calculate the angle based on the reference direction detected by the reference sensor and the displacement detected by the displacement sensor.

According to the present embodiment, the touch pen (50) includes the pen body part (53) having the attaching part to which the pen tip (51) is attached and the pen tip is capable of three-dimensionally displaced around the attaching part (52). Further, the pen body part includes a reference sensor to detect a reference direction on the display screen and the displacement sensor to detect the three-dimensional displacement of the pen tip. For example, when the axial direction of the pen body part is set to be the Z axis and the X axis and the Y axis are provided, the pen tip may be displaced with the pen body part in the X-axis, Y-axis and Z-axis directions. As the displacement sensor, for example, the pressure sensor may be used and when a user holds the pen body part of the touch pen and the pen tip is touched to the display screen, even though the pen body part is inclined or directed in any direction, the displacement sensor may detect the displacement of the pen tip. Further, as the reference sensor, for example, an accelerator sensor, a geomagnetic sensor or the like may be used. The calculation unit calculates the angle based on the reference direction and the displacement which are detected by the reference sensor and the displacement sensor. Therefore, when a user holds the pen body part of the touch pen and the pen tip is touched to the display screen, even though the pen body part is inclined or directed in any direction, the angle between the direction on the display screen with respect to the direction of the pen tip and the reference direction may be obtained based on the displacement and the reference direction of the pen tip.

The touch panel apparatus of the present embodiment is characterized in that, the reference direction is a gravity direction.

According to the present, for example, when the display screen of the touch panel apparatus is the upright type, that is, when the display panel is vertically disposed along a vertical plane, as the reference direction of the display screen, the gravity direction may be used. Therefore, it is possible to specify the direction in which the direction of the pen tip is directed on the display screen.

The touch panel apparatus of the present embodiment is characterized in that, the reference direction is a geomagnetic direction.

According to the embodiment of the present invention, for example, when the display screen of the touch panel apparatus is the table type, that is, when the display panel is horizontally disposed in the horizontal direction, as the reference direction of the display screen, the geomagnetic direction (for example, north or the like) may be used. Therefore, it is possible to specify the direction in which the direction of the pen tip is directed on the display screen.

The display apparatus of the present embodiment is characterized by including: the touch panel apparatus (100) according to any one of the above-described inventions; and the drawing unit (200) configured to draw an image of a writing brush shape which is formed in a wide width toward the direction. determined by the determination unit (64) on the display screen (10).

In the present embodiment, further, the drawing unit (200) draws the image of the writing brush shape which is formed in a wide width toward the direction determined by the drawing direction determination unit, on the display screen. That is, the image is drawn in narrow width at the early stage of the writing-out of the writing brush and is drawn in a gradually wide width as the pen tip moves. Therefore, even when a user moves the pen tip in any direction, the image of the writing brush shape having a changing width depending on to the moving direction of the pen tip may be drawn. Technical features described in the above embodiments of the present invention can form a new technical solution in combination with each other.

As this description may be embodied in. several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A touch screen apparatus which includes a display screen, and is configured to detect a position when a pen tip of a touch pen is touched to the display screen, and draw an image of a writing brush shape at the detected position, the touch screen apparatus comprising:
a calculation unit configured to calculate an angle between a direction in which a direction of the pen tip is projected on the display screen when the pen tip of the touch pen is touched to the display screen and a reference direction on the display screen; and
a determination unit configured to determine a direction of the image of the writing brush shape which is drawn depending on the angle calculated by the calculation unit.

2. The touch screen apparatus according to claim 1, wherein the touch pen includes:
a pen body part having an attaching part to which the pen tip is attached,
wherein the pen tip is capable of being three-dimensionally displaced around the attaching part, and
the pen body part includes:
a reference sensor configured to detect the reference direction on the display screen; and
a displacement sensor configured to detect three-dimensional displacement of the pen tip,
wherein the calculation unit is configured to calculate the angle based on the reference direction detected by the reference sensor and the displacement detected by the displacement sensor.

3. The touch screen apparatus according to claim 1, wherein the reference direction is a gravity direction.

4. The touch screen apparatus according to claim 2, wherein the reference direction is a gravity direction

5. The touch screen apparatus according to claim 1, wherein the reference direction is a geomagnetic direction.

6. The touch screen apparatus according to claim 2, wherein the reference direction is a geomagnetic direction.

7. A display apparatus, comprising: the touch screen apparatus according to claim 1; and a drawing unit configured to draw an image of a writing brush shape which is formed in a wide width toward the direction determined by the determination unit on the display screen.
